(19) United States
(12) Patent Application Publication
(10) Pub. No.: US 2002/0178105 A1
(43) Pub. Date: Nov. 28, 2002

(54) Systems and methods to facilitate a display of investment information associated with a plurality of share prices

(76) Inventor: Joshua Levine, New York, NY (US)

Correspondence Address: BUCKLEY, MASCHOFF, TALWALKAR, & ALLISON, 5 ELM STREET, NEW CANAAN, CT, 06840, US

(21) Appl. No.: 09/841,631

(22) Filed: Apr. 24, 2001

(51) Int. Cl. G06F 17/60

(52) U.S. Cl. 705/37

(57) ABSTRACT

Systems and methods are provided to facilitate a display of investment information associated with a plurality of share prices. According to one embodiment, an amount of shares bid associated with each of a plurality of bid prices is determined for an investment. An amount of shares offered associated with each of a plurality of ask prices is also determined for the investment. It is then arranged for indications of the amounts of shares bid and the amounts of shares offered to be graphically displayed. For example, an investment chart may include lines that represent a number of stock shares bid for each of a plurality of bid prices and a number of stock shares offered for each of a plurality of ask prices so as to provide an investor with a direct sense of market depth associated with the investment.

### FIELD

The present invention relates to investments. In particular, the present invention relates to systems and methods to facilitate a display of investment information associated with a plurality of share prices.

### BACKGROUND

Traditionally, shares of an investment were traded using fractional trading systems. For example, shares of “ABC Co.” stock might have been offered to be purchased at “$47 11/32” (i.e., $47.34375) or sold at “$47 13/32” (i.e., $47.40625) as illustrated in Table I.

TABLE I
Bid and Offer Information for ABC Co. (Fractional Trading System)

| | |
|---|---|
| Bids | Offers |

| Shares | Bid Price | Shares | Ask Price |
|---|---|---|---|
| 1,500 | $47 11/32* | 2,000 | $47 13/32* |
| 2,200 | $47 10/32 | 1,900 | $47 14/32 |
| 1,800 | $47 10/32 | 1,500 | $47 15/32 |
| 2,000 | $47 9/32 | 2,000 | $47 16/32 |
| 1,400 | $47 8/32 | 2,100 | $47 16/32 |

In particular, Table I illustrates that there are multiple outstanding bids to purchase particular amounts of the stock at various prices (e.g., there is one outstanding bid to purchase 1,500 shares at $47 11/32 and another outstanding bid to purchase 2,200 shares at $47 10/32). Similarly, there are multiple outstanding offers to sell the stock at various prices (e.g., “ask prices”). Note that the information in Table I would dynamically change when a potential investor submits a new bid or offer or cancels an outstanding bid or offer. The information would also change when an outstanding bid is matched with an appropriate outstanding offer (e.g., when a sale of the investment is arranged between investors).

To give interested investors an indication of an investment's current value, the maximum outstanding bid price and the minimum outstanding ask price (e.g., as noted with an * in Table I) are typically displayed. For example, a newspaper or an investment Web site may display “ABC Co.—Bid $47 11/32, Ask $47 13/32” to an interested investor.

Recently, however, decimal trading systems have been introduced to facilitate the trading of investment shares. For example, shares of ABC Co. stock might be offered to be purchased at “$47.320” or sold at “$47.340” as illustrated in Table II.

TABLE II
Bid and Offer Information for ABC Co. (Decimal Trading System)

| | |
|---|---|
| Bids | Offers |

| Shares | Bid Price | Shares | Offer Price |
|---|---|---|---|
| 50 | $47.320* | 75 | $47.340* |
| 100 | $47.316 | 50 | $47.342 |
| 50 | $47.315 | 25 | $47.343 |
| 75 | $47.315 | 25 | $47.343 |
| 35 | $47.312 | 50 | $47.344 |

Note that the decimal system is more precise than the fractional system. That is, the number of increments at which an inventor can offer to purchase or sell a stock has been increased (e.g., from thirty two in a fractional system that used 1/32 increments to one thousand in a decimal system that uses three decimal places). As a result, the total number of shares that are offered to be purchased or sold at each particular increment has been reduced. In the example illustrated in the Tables I and II, the number of shares associated with the maximum outstanding bid price has been reduced from 1,500 shares to 50 shares.

The reduction in the number of shares associated with the maximum outstanding bid price and the minimum outstanding ask price has significantly reduced the usefulness of this information to investors interested in an investment's current value. Consider, for example a newspaper or an investment Web site that displays “ABC Co.—Bid $47.320, Ask $47.340” to an interested investor. If the investor is interested in purchasing 500 shares of the stock, these values do not provide sufficient information to determine an actual price he or she will need to pay to purchase those shares. That is, the investor is only being told the ask price associated with the first 75 shares of his or her purchase. The meaning of a maximum outstanding bid price to an investor interested in selling shares of a stock has similarly been reduced by the introduction of decimal trading systems. In other words, the information does not indicate to the investor the market “depth” associated with the investment (e.g., the supply of and demand for the investment at various prices and/or various amounts of shares).

### SUMMARY

To alleviate problems inherent in the prior art, the present invention introduces systems and methods to facilitate a display of investment information associated with a plurality of share prices.

According to one embodiment of the present invention, an amount of shares bid associated with each of a plurality of bid prices is determined for an investment along with an amount of shares offered associated with each of a plurality of ask prices. It is then arranged for indications of the amounts of shares bid and the amounts of shares offered to be graphically displayed. Such a graphical display may provide an investor with a direct sense of market depth associated with the investment

Another embodiment is directed to a computer-implemented method of facilitating a display of information associated with shares of a stock. According to this embodiment, an indication associated with the stock is received from an investor. A number of shares bid associated with each of a plurality of bid prices is then determined for the stock along with a number of shares offered associated with each of a plurality of ask prices. It is arranged for an investment chart to be displayed to the investor, the investment chart including: (i) a first axis associated with share prices, and (ii) a second axis associated with numbers of shares bid and offered. It is also arranged for indications of the numbers of shares bid and the numbers of shares offered to be displayed to the investor on the investment chart so as to provide an investor with a direct sense of market depth associated with the investment.

According to another embodiment, an amount of shares bid associated with each of a plurality of bid prices is determined for an investment, and a bid value is calculated based on the amounts of shares bid and the bid prices. An amount of shares offered associated with each of a plurality of ask prices is also determined for the investment, and an ask value is determined based on the amounts of shares offered and the ask prices. It is then arranged for the bid value and the ask value to be displayed.

According to still another embodiment, a plurality of bid prices (associated with a pre-determined number of shares bid) is determined for an investment, and a bid value is calculated based on the bid prices. A plurality of ask prices (associated with a pre-determined number of shares offered) is also determined for the investment, and an ask value is calculated based on the ask prices. It is then arranged for the bid value and the ask value to be displayed.

According to yet another embodiment, an amount of shares bid associated with each of a plurality of bid prices is determined for an investment along with an amount of shares offered associated with each of a plurality of ask prices. A current value is calculated based on the amounts of shares bid, the bid prices, the amounts of shares offered, and the ask prices. It is then arranged for the current value to be displayed.

According to another embodiment, information associated with an investment is requested (e.g., for an investor). A graphical display is then provided, including (i) an indication of amounts of shares bid associated with each of a plurality of bid prices and (ii) an indication of amounts of shares offered associated with each of a plurality of ask prices. Such a graphical display may provide a direct sense of market depth associated with the investment

One embodiment of the present invention comprises: means for determining an amount of shares bid associated with each of a plurality of bid prices for an investment; means for determining an amount of shares offered associated with each of a plurality of ask prices for the investment; and means for arranging for indications of the amounts of shares bid and the amounts of shares offered to be graphically displayed.

Another embodiment comprises: means for receiving from an investor an indication associated with a stock; means for determining a number of shares bid associated with each of a plurality of bid prices for the stock; means for determining a number of shares offered associated with each of a plurality of ask prices for the stock; means for arranging for an investment chart to be displayed to the investor, the investment chart including: (i) a first axis associated with share prices, and (ii) a second axis associated with numbers of shares bid and offered; and means for arranging for indications of the numbers of shares bid and the numbers of shares offered to be displayed to the investor on the investment chart so as to provide an investor with a direct sense of market depth associated with the investment.

Another embodiment comprises: means for determining an amount of shares bid associated with each of a plurality of bid prices for an investment; means for calculating a bid value based on the amounts of shares bid and the bid prices; means for determining an amount of shares offered associated with each of a plurality of ask prices for the investment; means for calculating an ask value based on the amounts of shares offered and the ask prices; and means for arranging for the bid value and the ask value to be displayed.

Another embodiment comprises: means for determining a plurality of bid prices for an investment associated with a pre-determined number of shares bid; means for calculating a bid value based on the bid prices; means for determining a plurality of ask prices for the investment associated with a pre-determined number of shares offered; means for calculating an ask value based on the ask prices; and means for arranging for the bid value and the ask value to be displayed.

Still another embodiment comprises: means for determining an amount of shares bid associated with each of a plurality of bid prices for an investment; means for determining an amount of shares offered associated with each of a plurality of ask prices for the investment; means for calculating a current value based on the amounts of shares bid, the bid prices, the amounts of shares offered, and the ask prices; and means for arranging for the current value to be displayed.

Yet another embodiment comprises: means for requesting information associated with an investment; and means for providing a graphical display including (i) an indication of amounts of shares bid associated with each of a plurality of bid prices and (ii) an indication of amounts of shares offered associated with each of a plurality of ask prices.

With these and other advantages and features of the invention that will become hereinafter apparent, the invention may be more clearly understood by reference to the following detailed description of the invention, the appended claims, and the drawings attached herein.

### BRIEF DESCRIPTION OF THE DRAWINGS

FIG. 1 is a block diagram overview of an investment information system according to an embodiment of the present invention.

FIG. 2 is a flow chart of a method for facilitating a display of investment information according to an embodiment of the present invention.

FIG. 3 illustrates investment information displays according to some embodiments of the present invention.

FIG. 4 is a block diagram of an investment information display device according to an embodiment of the present invention.

FIGS. 5 through 7 illustrate investor information display devices according to some embodiments of the present invention.

FIG. 8 is a block diagram of an investment information controller according to an embodiment of the present invention.

FIG. 9 is a tabular representation of a portion of a bid database according to an embodiment of the present invention.

FIG. 10 is a tabular representation of a portion of an offer database according to an embodiment of the present invention.

FIG. 11 is a flow chart of a computer-implemented method for facilitating a display of investment information associated with shares of a stock according to one embodiment of the present invention.

FIG. 12 is a flow chart of a method for facilitating a display of investment information according to another embodiment of the present invention.

### DETAILED DESCRIPTION

Embodiments of the present invention are directed to systems and methods to facilitate a display of investment information associated with a plurality of share prices. The investment information may be associated with, for example, an equity investment (e.g., a stock), a debt investment (e.g., a bond), or a fund of investments.

Moreover, as used herein, the term “investor” refers to any party interested in an investment, including parties that may potentially purchase or sell shares of the investment. The term investor also refers to a broker or dealer who is interested in purchasing or selling shares on behalf of another party.

### Investment Information System Overview

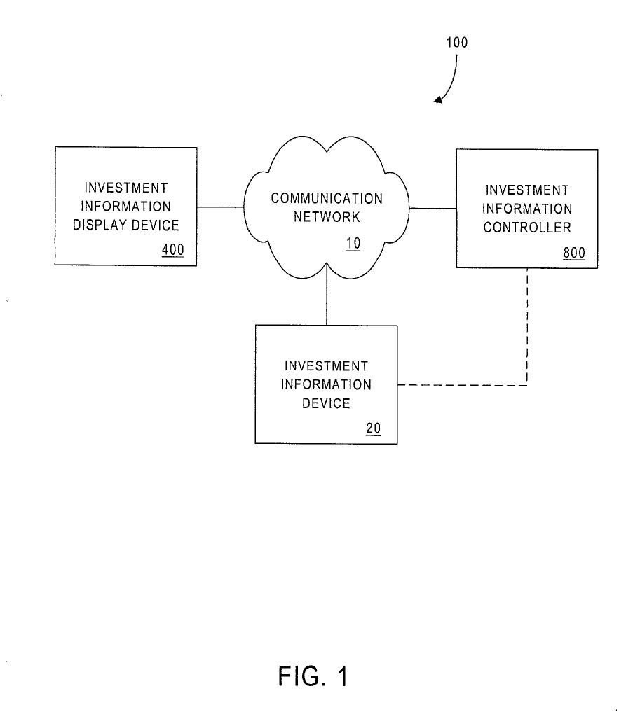

Turning now in detail to the drawings, FIG. 1 is a block diagram overview of an investment information system 100 according to one embodiment of the present invention. The investment information system 100 includes an investment information controller 800 in communication with a remote investment information display device 400. As used herein, devices (such as the investment information display device 400 and the investment information controller 800) may communicate, for example, via a communication network 10, such as a Local Area Network (LAN), a Metropolitan Area Network (MAN), a Wide Area Network (WAN), a proprietary network, a Public Switched Telephone Network (PSTN), a Wireless Application Protocol (WAP) network, a cable television network, or an Internet Protocol (IP) network such as the Internet, an intranet or an extranet. Note that although a single investment information controller 800 is shown in FIG. 1, any number of investment information controllers 800 may be included in the investment information system 100. Similarly, any number of the other devices described herein may be included in the investment information system 100 according to embodiments of the present invention.

In one embodiment, the investment information display device 400 communicates with a remote, Web-based investment information controller 800 (e.g., a server) via the Internet. Although some embodiments are described with respect to information exchanged via a Web site, according to other embodiments information is instead exchanged, for example, via: a telephone, a WEBTV® interface, a cable network interface, and/or a wireless communication system.

The investment information display device 400 and the investment information controller 800 may be any devices capable of performing various functions described herein. The investment information display device 400 may be, for example: a PC, a portable computing device such as a Personal Digital Assistant (PDA), a dedicated investment terminal, a wireless telephone, a two-way pager, an interactive television device, or any other appropriate storage and/or communication device. According to another embodiment, the investment information display device 400 comprises a printed publication (e.g., a newspaper).

Note that the devices shown in FIG. 1 need not be in constant communication. For example, the investment information display device 400 might only communicate with the investment information controller 800 via the Internet when appropriate (e.g., when attached to a “docking” station or “cradle” coupled to the investor's PC).

An investor can use the investment information display device 400 to receive information associated with an investment. For example, an investor may view an investment chart that graphically indicates amounts of shares bid associated with a number of bid prices along with amounts of shares offered associated with a number of ask prices. The investment information display device 400 may also be used to provide or generate investor inputs. For example, an investor may use a keyboard or mouse coupled to his or her PC to provide an indication of a particular stock to the investment information controller 800 (e.g., by typing the stock's “ticker” symbol).

The investment information controller 800 may also communicate with an investment information device 20. The investment information device 20 may be any device capable of providing, for example, the number of shares bid associated with each of a plurality of bid prices and/or the number of shares offered associated with each of a plurality of ask prices. The investment information controller 800 may communicate with the investment information device 20 via the communication network 10 or through another channel (as illustrated by the dashed line in FIG. 1).

The investment information device 20 may be associated with, for example, an Exchange Control Network (ECN), such as the ISLAND® ECN. An ECN is a computerized system that automatically matches orders between buyers and sellers, and has been recognized as such under the Securities and Exchange Commission (SEC) ECN Display Alternative Rule.

The investment information device 20 may also be associated with, for example, the National Association of Securities Dealers Automated Quotation System (NASDAQ) or a New York Stock Exchange (NYSE) trading system.

Although a separate investment information display device 400, investment information controller 800, and investment information device 20 are illustrated in FIG. 1. Some or all of the devices may be incorporated in a single device. For example, an ECN may act as both an investment information device 20 and an investment information controller 800.

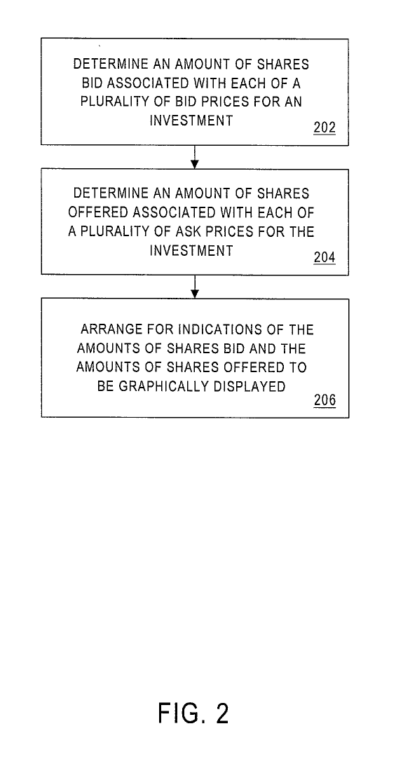

FIG. 2 is a flow chart of a method for facilitating a display of investment information according to an embodiment of the present invention. The flow charts in FIG. 2 and the other figures described herein do not imply a fixed order to the steps, and embodiments of the present invention can be practiced in any order that is practicable. Moreover, the methods may be performed by any of the devices described herein. The method shown in FIG. 2 may be performed, for example, by the investment information controller 800.

At 202, an amount of shares bid associated with each of a plurality of bid prices are determined for an investment. For example, the investment information controller 800 may receive information from the investment information device 20 to determine a number of shares bid associated with each of a plurality of bid prices for a stock.

At 204, an amount of shares offered associated with each of a plurality of ask prices are determined for the investment. For example, the investment information controller 800 may receive information from the investment information device 20 to determine a number of shares offered associated with each of a plurality of ask prices for a stock.

At 206, it is arranged for indications of the amounts of shares bid and the amounts of shares offered to be graphically displayed. For example, the investment information controller 800 may transmit information to the investment information display device 400 to arrange for an investment chart to be displayed to an investor.

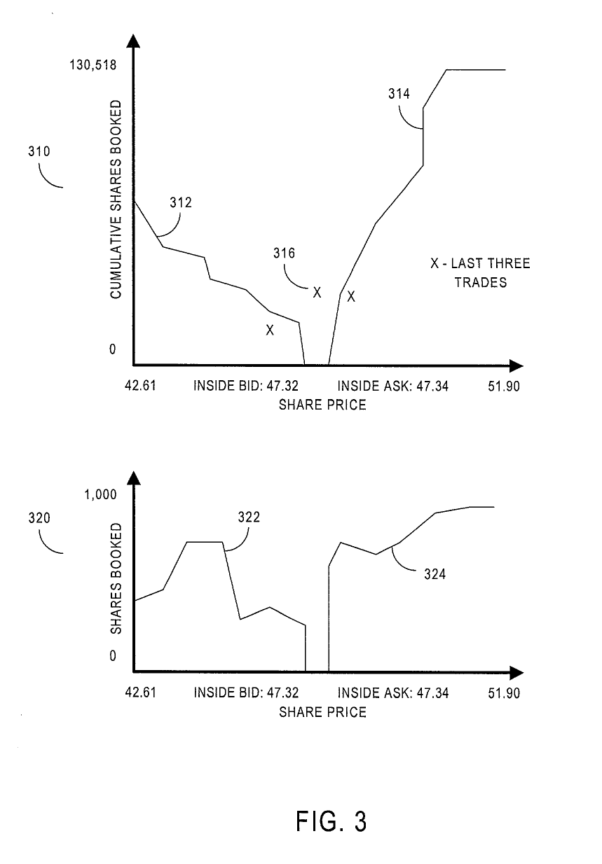

FIG. 3 illustrates investment information displays 310 and 320 associated with market depth charts according to some embodiments of the present invention. The first investment information display 310 includes a horizontal axis representing share price. The share price may represent, for example, a price at which investors are willing to purchase or sell shares of a stock (e.g., a decimal dollar value).

The first investment information display 310 also includes a vertical axis representing a cumulative number of shares for which there are outstanding orders to purchase or sell the stock (i.e., cumulative shares “booked”). For example, each point on line 312 represents a total number of shares that investors are currently willing to purchase at or above a specific share price (e.g., associated with a number of different bids from different investors). As can be seen, the maximum bid price is currently $47.32 (i.e., the “inside bid”).

Similarly, each point on line 314 represents a total number of shares that investors are currently willing to sell at or below a specific share price (e.g., associated with a number of different offers from different investors). As can be seen, the minimum ask price is currently $47.34 (i.e., the “inside ask”).

By providing this information to an investor, he or she may be able to understand actual supply and demand forces associated with the investment. In contrast, simply displaying the maximum current bid price and minimum current ask price (e.g., “$47.32” and “$47.34”) would not provide the investor with this information. For example, as illustrated in the first investment information display 310, an investor may be able to directly determine that there is currently more interest in selling an investment as compared to purchasing the investment (e.g., as represented by the smaller area under line 312 as compared to line 314 ). Moreover, the investor may be able to rapidly evaluate market interest at various prices and/or various amounts of shares.

In addition, an investor interested in purchasing or selling a particular number of shares (e.g., 10,000 shares) can quickly determine a current maximum price that he or she may need to pay to purchase that number of shares (e.g., via line 314 ) or a current minimum price that he or she may receive if that number of shares are sold (e.g., via line 312 ).

Moreover, by providing this information to an investor graphically, he or she will be able to more readily understand the information and gauge market depth associated with the investment (e.g., as compared to a table of numbers containing share prices and numbers shares booked). In other words, the graphical display provides the investor with a direct sense of market “depth” associated with the investment. As used herein, market “depth” may refer to a current supply of and/or demand for an investment at various prices and/or amounts of investment.

Note that by displaying numerical information (e.g., the inside bid and the inside ask) in addition to graphical information, an investor may be able to more readily comprehend an investment information display.

The first investment information display 310 also includes a graphical indication 316 of at least one previous trade (e.g., the share prices and the number of shares associated with the last three trades are indicated with an “X”). Such an indication 316 may, for example, let an investor more readily comprehend actual supply and demand forces associated with the investment.

As another example, consider the second investment information display 320 illustrated in FIG. 3, which also includes a horizontal axis representing share price. The second investment information display 320 also includes a vertical axis representing a number of shares for which there are outstanding orders to purchase or sell the stock at a particular price (i.e., shares booked as opposed to “cumulative” shares booked). For example, each point on line 322 represents a total number of shares that investors are currently willing to purchase at a specific share price. Similarly, each point on line 324 represents a total number of shares that investors are currently willing to sell at a specific share price.

Note that instead of lines, the indications provided in the investment information displays 310 and 320 may be represented by points, bars, symbols, and/or colors (e.g., a single multi-color line may be displayed with darker colors indicating larger numbers of shares). Moreover, additional information can be displayed on the investment chart according to embodiments of the present invention. For example, a single investment chart may contain information associated with a number of different investments or with a single investment over a period of time (e.g., a three-dimensional investment chart may include a third axis representing time).

Note that any of the information described herein may be displayed on a different axis than is illustrated in FIG. 3. Moreover, other information can be displayed on the investment chart instead of the information illustrated in FIG. 3. For example, according to another embodiment, the horizontal axis represents an “average” share price. That is, the price represents an average price per share an investor may currently need to provide to purchase a particular number of shares (e.g., taking into consideration that different shares will need to be purchased at different prices) or an average price per share an investor may currently receive if a particular number of shares are sold (e.g., taking into consideration that different shares will need to be sold at different prices).

The investment information displays 310 and 320 may be based on information that is determined in substantially real-time (e.g., based on information received from an ECN associated with outstanding bids and offers from investors). Moreover, the information may be updated in substantially real-time.

### Investment Information Display Device

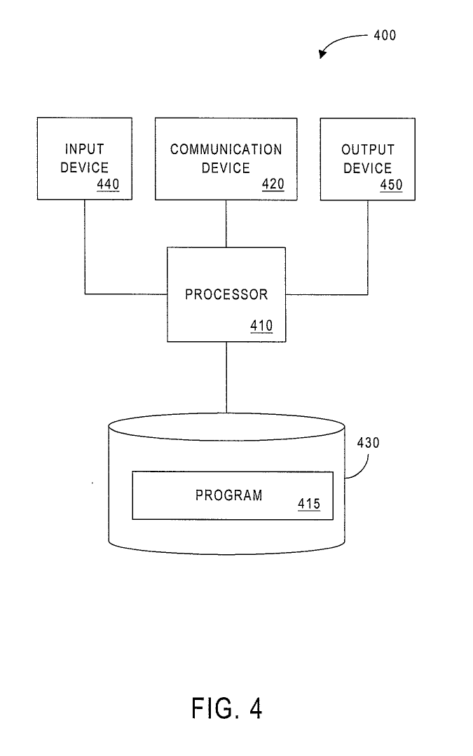

FIG. 4 illustrates an investment information display device 400 that is descriptive of the device shown in FIG. 1 according to an embodiment of the present invention. The investment information display device 400 comprises a processor 410, such as one or more INTEL® Pentium® processors, coupled to a communication device 420 configured to communicate via a communication network (not shown in FIG. 4). The communication device 420 may be used to communicate, for example, with the investment information controller 800 and/or the investment information device 20.

The processor 410 is also in communication with an input device 440. The input device 440 may comprise, for example, a keyboard, a mouse or other pointing device, a microphone, a knob or a switch (including an electronic representation of a knob or a switch), an infrared port, a docking station, and/or a touch screen. Such an input device 440 may be used, for example, to provide an indication of a particular investment of interest to the investor (e.g., by typing an indication associated with a stock).

The processor 410 is also in communication with an output device 450. The output device 440 may comprise, for example, a display (e.g., a computer monitor), a speaker, and/or a printer. The output device 450 may be used, for example, to provide investment information to an investor (e.g., by displaying an investment chart to the investor).

The processor 410 is also in communication with a storage device 430. The storage device 430 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

The storage device 430 stores a program 415 for controlling the processor 410. The processor 410 performs instructions of the program 415, and thereby operates in accordance with the present invention. For example, the processor 410 may request information associated with an investment (e.g., by transiting an indication of the investment to the investment information controller 800 ). The processor 410 may also provide and/or generate a graphical display including (i) an indication of amounts of shares bid associated with each of a plurality of bid prices and (ii) an indication of amounts of shares offered associated with each of a plurality of ask prices.

As used herein, information may be “received” by or “transmitted” to, for example: (i) the investment information display device 400 from the investment information controller 800 or the investment information device 20; or (ii) a software application or module within the investment information display device 400 from another software application, module, or any other source.

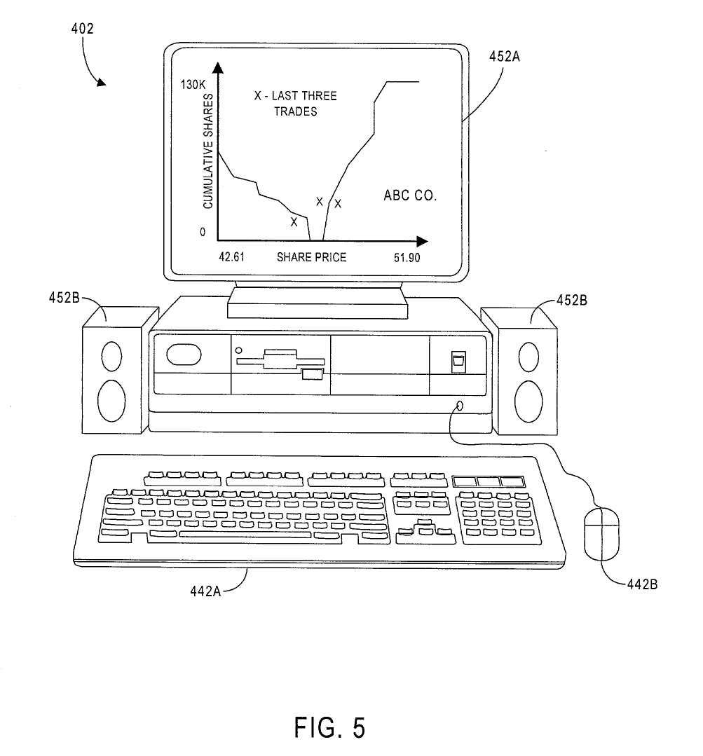

FIG. 5 illustrates a PC 402 displaying investment information according to one embodiment of the present invention. The PC 402 includes a keyboard 442A and a mouse 442B which can be used by an investor to provide investor inputs (e.g., a stock's “ticker” symbol). The PC 402 also includes a computer display 452A and speakers 452B which can be used, for example, to provide investment information to an investor.

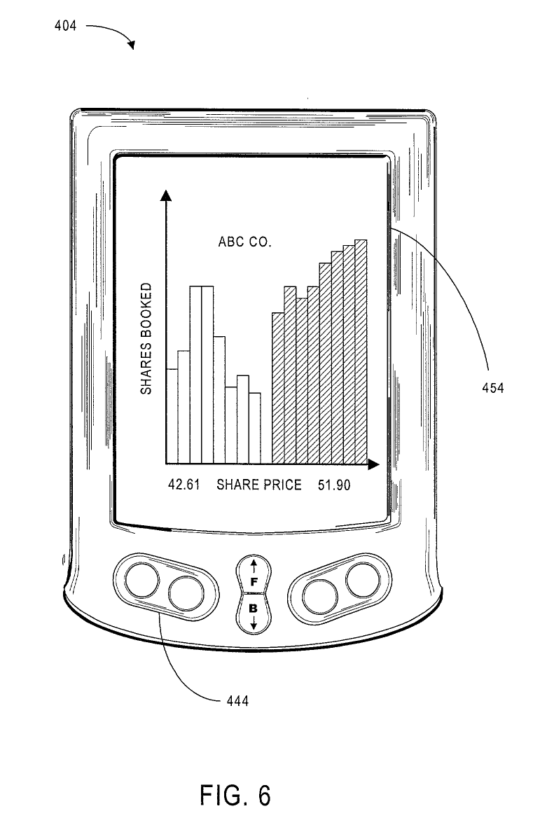

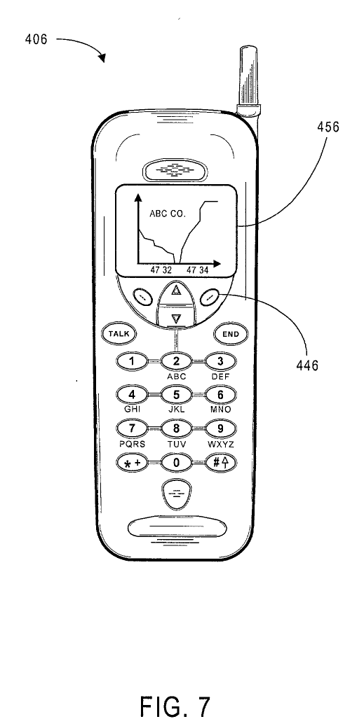

FIG. 6 illustrates a PDA 404 displaying investment information according to another embodiment of the present invention. The PDA 404 includes an input device 444 and an output device 454 (e.g., a display screen) that may be used to display investment information. Similarly, FIG. 7 illustrates a wireless telephone 406 including an input device 446 and an output device 456 displaying investment information.

### Investment Information Controller

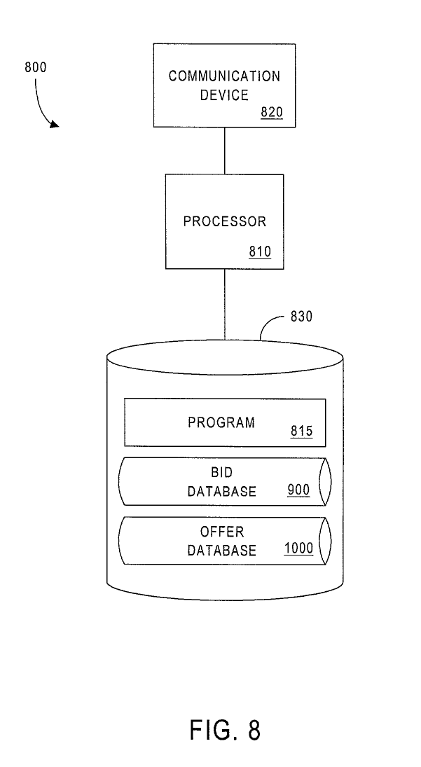

FIG. 8 illustrates an investment information controller 800 that is descriptive of the device shown in FIG. 1 according to an embodiment of the present invention. The investment information controller 800 comprises a processor 810, such as one or more INTEL® Pentium® processors, coupled to a communication device 820 configured to communicate via a communication network (not shown in FIG. 8). The communication device 820 may be used to communicate, for example, with one or more investment information display devices 400 and/or investment information devices 20.

The processor 810 is also in communication with a storage device 830. The storage device 830 may comprise any appropriate information storage device, including combinations of magnetic storage devices (e.g., magnetic tape and hard disk drives), optical storage devices, and/or semiconductor memory devices such as RAM devices and ROM devices.

The storage device 830 stores a program 815 for controlling the processor 810. The processor 810 performs instructions of the program 815, and thereby operates in accordance with any embodiments of the present invention described herein. For example, the processor 810 may determine an amount of shares bid associated with each of a plurality of bid prices for an investment (e.g., by receiving information from the investment information device 20). The processor 810 may also determine an amount of shares offered associated with each of a plurality of ask prices for the investment. The processor 810 may then arrange for indications of the amounts of shares bid and the amounts of shares offered to be graphically displayed (e.g., by transmitting appropriate information to the investment information display device 400) so as to provide an investor with a direct sense of market depth associated with the investment.

According to another embodiment, the processor 810 receives from an investor an indication associated with a stock (e.g., the stock's “ticker” symbol). The processor 810 determines a number of shares bid associated with each of a plurality of bid prices along with a number of shares offered associated with each of a plurality of ask prices for the stock. The processor 810 then arranges for an investment chart to be displayed to the investor (e.g., via the information display device 400), the investment chart including a first axis associated with share prices a second axis associated with numbers of shares bid and offered. The processor 810 also arranges for indications of the numbers of shares bid and the numbers of shares offered to be displayed to the investor on the investment chart.

The program 815 may be stored in a compressed, uncompiled and/or encrypted format. The program 815 may furthermore include other program elements, such as an operating system, a database management system, and/or device drivers used by the processor 810 to interface with peripheral devices.

As used herein, information may be “received” by or “transmitted” to, for example: (i) the investment information controller 800 from the investment information display device 400 or the investment information device 20; or (ii) a software application or module within the investment information controller 800 from another software application, module, or any other source.

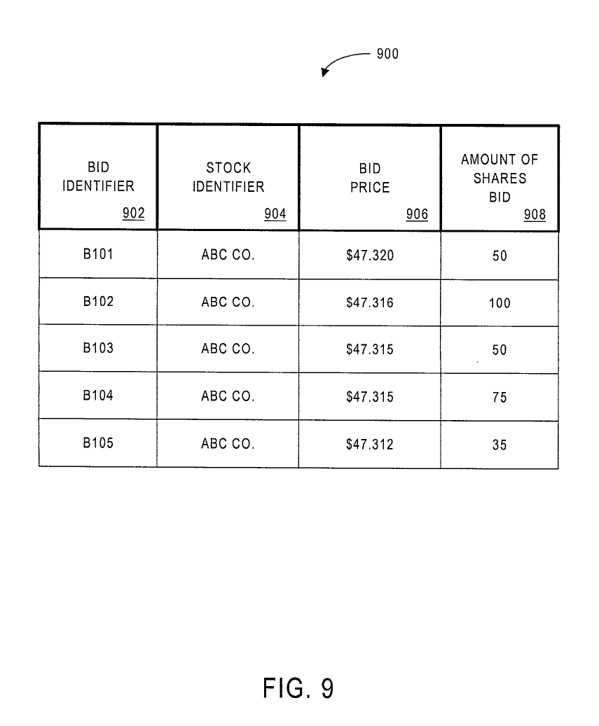

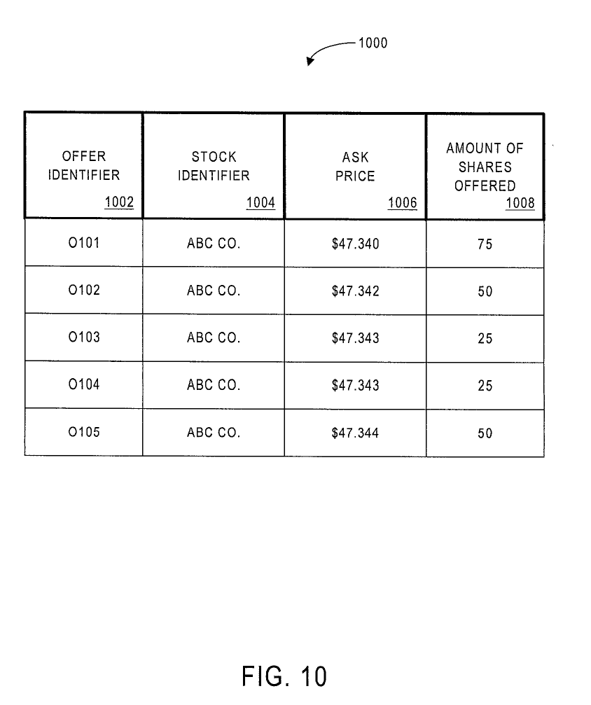

As shown in FIG. 8, the storage device 830 also stores a bid database 900 and an offer database 1000. Examples of databases that may be used in connection with the investment information controller 800 will now be described in detail with respect to FIGS. 9 and 10. The illustrations and accompanying descriptions of the databases presented herein are exemplary, and any number of other database arrangements could be employed besides those suggested by the figures.

### Bid Database

Referring to FIG. 9, a table represents the bid database 900 that may be stored at the investment information controller 800 according to an embodiment of the present invention. The table includes entries identifying bids to purchase an investment. The table also defines fields 902, 904, 906, and 908 for each of the entries. The fields specify: a bid identifier 902, a stock identifier 904, a bid price 906, and an amount of shares bid 908. The information in the bid database 900 may be created and updated, for example, based on information received from the investment information device 20 (e.g., an ECN, NASDAQ, or NYSE trading system).

The bid identifier 902 may be, for example, an alphanumeric code associated with a particular bid to purchase an investment identified by the stock identifier 904. The bid price 906 indicates a particular price at which a buyer is offering to purchase the investment, and the amount of shares bid 908 indicates the number of shares he or she is currently offering to purchase at the bid price 906.

### Offer Database

Referring to FIG. 10, a table represents the offer database 1000 that may be stored at the investment information controller 800 according to an embodiment of the present invention. The table includes entries identifying offers to sell an investment. The table also defines fields 1002, 1004, 1006, and 1008 for each of the entries. The fields specify: an offer identifier 1002, a stock identifier 1004, an ask price 1006, and an amount of shares offered 1008. The information in the offer database 1000 may be created and updated, for example, based on information received from the investment information device 20 (e.g., an ECN, NASDAQ, or NYSE trading system).

The offer identifier 1002 may be, for example, an alphanumeric code associated with a particular offer to sell an investment identified by the stock identifier 1004. The ask price 1006 indicates a particular price at which a seller is offering to sell the investment, and the amount of shares offered 1008 indicates the number of shares he or she is currently offering to sell at the ask price 1006.

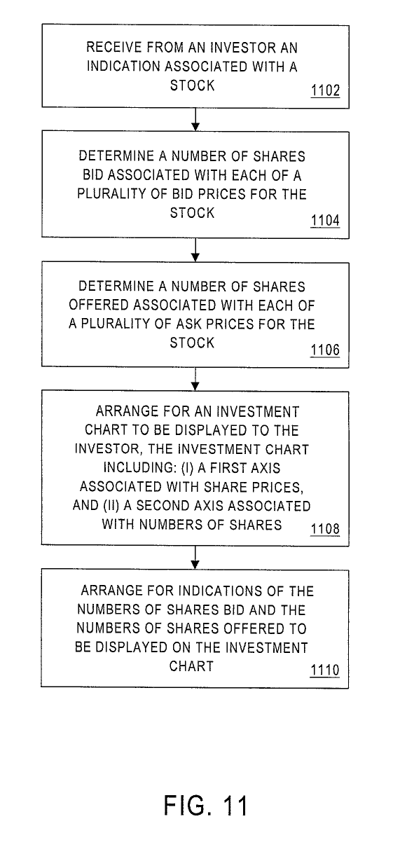

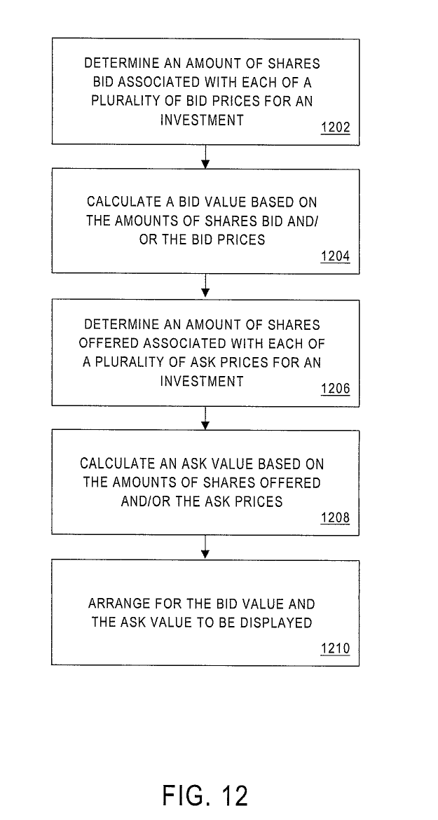

Methods that may be used in connection with the investment information system 100 according to some embodiments of the present invention will now be described in detail with respect to FIGS. 11 and 12.

### Investment Information System Methods

FIG. 11 is a flow chart of a computer-implemented method for facilitating a display of investment information associated with shares of a stock according to one embodiment of the present invention. The method shown in FIG. 11 may be performed, for example, by the investment information controller 800. At 1102, an indication associated with the stock is received from an investor. For example, the investment information controller 800 may receive an indication of the stock's four-letter ticker symbol from an investment information display device 400.

At 1104, an amount of shares bid associated with each of a plurality of bid prices is determined for the stock. For example, the investment information controller 800 may retrieve amounts of shares bid 908 and bid prices 906 from the bid database 900 based on the stock identifier 904 and the received indication.

At 1106, an amount of shares offered associated with each of a plurality of ask prices is determined for the stock. For example, the investment information controller 800 may retrieve amounts of shares offered 1008 and ask prices 1006 from the offer database 1000 based on the stock identifier 1004 and the received indication.

At 1108, it is arranged for an investment chart to be displayed to the investor, the investment chart including: (i) a first axis associated with share prices, and (ii) a second axis associated with numbers of shares bid and offered. At 1110, it is arranged for indications of the amounts of shares bid and the amounts of shares offered to be displayed to the investor on the investment chart. For example, the investment information controller 800 may transmit information to the investment information display device 400 to arrange for the investment chart to be graphically displayed to the investor.

Some embodiments of the present invention are directed to graphical displays of investment information. According to another embodiment, one or more investment values are instead displayed to an investor. Note that any of the values described herein may be displayed to an inventor in a numerical or graphical form (e.g., the value may be graphically represented on the investment information displays described with respect to FIG. 3). FIG. 12 is a flow chart of a method for facilitating a display of investment information according to one such embodiment.

At 1202, an amount of shares bid associated with each of a plurality of bid prices is determined for an investment. For example, the investment information controller 800 may retrieve amounts of shares bid 908 and bid prices 906 from the bid database 900.

The plurality of bid prices may represent, for example, all outstanding bids. According to another embodiment, the plurality of bid prices are associated with a pre-determined range of bid prices relative to a maximum outstanding bid price. For example, the investment information controller 800 may retrieve information associated with a bid having the maximum current bid price 906 and all bids having a bid price 906 within $0.10 of that maximum price. According to another embodiment, the plurality of bid prices are associated with a pre-determined threshold number of shares bid. For example, the investment information controller 800 retrieve information associated with the bid having the maximum current bid price 906 and other bids (in decreasing order of bid price 906) until the cumulative amount of shares bid 908 reaches some pre-determined threshold number of shares bid (e.g.,5,000 shares).

At 1204, a “bid value” is calculated based on the amounts of shares bid and/or the bid prices determined at 1202. For example, the bid value may represent an average value per share. According to another embodiment, the bid value represents a minimum bid price that was determined at 1202.

At 1206, an amount of shares offered associated with each of a plurality of ask prices is determined for the investment. For example, the investment information controller 800 may retrieve amounts of shares offered 1008 and ask prices 1006 from the offer database 1000.

The plurality of ask prices may represent, for example, all outstanding offers. According to another embodiment, the plurality of ask prices are associated with a pre-determined range of ask prices relative to a minimum outstanding ask price (e.g., within $0.005 of the minimum outstanding ask price). According to another embodiment, the plurality of ask prices are associated with a pre-determined threshold number of shares offered (e.g.,1,000 shares).

At 1208, an “ask value” is calculated based on the amounts of shares offered and/or the ask prices determined at 1206. For example, the ask value may represent an average value per share. According to another embodiment, the ask value represents a maximum ask price that was determined at 1206.

At 1210, it is arranged for the bid value and the ask value to be displayed. For example, the investment information controller 800 may transmit the bid value and the ask value to a remote investment information display device 400.

### Additional Embodiments

The following illustrates various additional embodiments of the present invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although some embodiments of the present invention have been described with respect to an investment information controller 800 arranging for information to be graphically displayed or calculating a value, either of these functions may instead be performed by an investment information display device 400. For example, the investment information display device 400 (e.g., an investor's PC) may determine an amount of shares bid associated with each of a plurality of bid prices along with an amount of shares offered associated with each of a plurality of ask prices by receiving the information from the investment information controller 800 and/or an investment information device 20 (e.g., an ECN, NASDAQ, or NYSE trading system). The PC may then process the information (e.g., in accordance with a Java program) to generate an investment chart or value, such as any of the investment charts or values as described herein.

Moreover, one embodiment of the present invention has been described with respect to the display of a bid value and an ask value to an investor (i.e., in relation to FIG. 12). According to a similar embodiment, a plurality of bid prices (associated with a pre-determined number of shares bid) are determined for an investment. A bid value is then calculated based on the bid prices. A plurality of ask prices (associated with a pre-determined number of shares offered) are also determined for the investment, and an ask value is calculated based on the ask prices. The bid values and ask values may comprise, for example, a medium, a mean, or a weighted average of the associated information. It is then arranged for the bid value and the ask value to be displayed.

According to yet another embodiment, only a single value is displayed to an investor. For example, an amount of shares bid associated with each of a plurality of bid prices may be determined for an investment along with an amount of shares offered associated with each of a plurality of ask prices. A “current” value is then calculated based on the amounts of shares bid, the bid prices, the amounts of shares offered, and the ask prices. For example, the current value may represent all of the prices (i.e., bid prices and ask prices), each price being weighted based on the associated number of shares (i.e., the amounts of shares bid or the amounts of shares offered, as appropriate). It is then arranged for the current value to be displayed to an investor.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A method of facilitating a display of investment information, comprising:
determining an amount of shares bid associated with each of a plurality of bid prices for an investment;
determining an amount of shares offered associated with each of a plurality of ask prices for the investment; and
arranging for indications of the amounts of shares bid and the amounts of shares offered to be graphically displayed so as to provide an investor with a direct sense of market depth associated with the investment.

2. The method of claim 1, wherein the indication of the amounts of shares bid and the indication of the amounts of shares offered are graphically displayed on a single investment chart.

3. The method of claim 2, wherein the indications comprise at least one of: (i) lines on the investment chart, (ii) points on the investment chart, (iii) bars on the investment chart, (iv) symbols on the investment chart, and (v) colors on the investment chart.

4. The method of claim 3, wherein the investment chart includes a first axis associated with share price and a second axis associated with at least one of: (i) a current number of shares bid and offered associated with share price, and (ii) a cumulative number of shares bid and offered.

5. The method of claim 3, wherein the investment chart includes a first axis associated with average share price and a second axis associated with a number of shares bid and offered.

6. The method of claim 3, wherein the investment chart includes a first axis associated with share price, a second axis associated with a number of shares bid and offered, and third axis associated with time.

7. The method of claim 3, wherein information associated with a plurality of investments are graphically displayed on the investment chart.

8. The method of claim 1, further comprising:
arranging for an indication of at least one previous trade to be graphically displayed.

9. The method of claim 1, wherein the investment is associated with at least one of: (i) an equity, (ii) a stock, (iii) a debt, (iv) a bond, and (v) a fund of investments.

10. The method of claim 1, wherein said arranging comprises:
exchanging information with an information display device via a communication network.

11. The method of claim 10, wherein the information display device comprises at least one of: (i) a personal computer, (ii) a portable computing device, (iii) a personal digital assistant, (iv) a telephone, (v) a wireless telephone, (vii) an interactive television device, and (viii) a kiosk.

12. The method of claim 10, wherein the communication network comprises at least one of: (i) the Internet, (ii) a public network, (iii) a public switched telephone network, (iv) a proprietary network, (v) a cable television network, (vi) a wireless network, and (vii) a local area network.

13. The method of claim 1, wherein said determinations are performed in substantially real-time based on information associated with investors.

14. The method of claim 13, further comprising:
updating the indications in substantially real-time based on information associated with investors.

15. The method of claim 1, wherein the bid prices and the ask prices comprise decimal values.

16. An apparatus, comprising:
a processor; and
a storage device in communication with said processor and storing instructions adapted to be executed by said processor to:
determine an amount of shares bid associated with each of a plurality of bid prices for an investment;
determine an amount of shares offered associated with each of a plurality of ask prices for the investment; and
arrange for indications of the amounts of shares bid and the amounts of shares offered to be graphically displayed so as to provide an investor with a direct sense of market depth associated with the investment.

17. The apparatus of claim 16, wherein said storage device further stores at least one of: (i) a bid database, and (ii) an offer database.

18. The apparatus of claim 16, further comprising:
a communication device coupled to said processor and adapted to communicate with at least one of: (i) an investment information display device, (ii) an investment information controller, and (iii) an investment information device.

19. A medium storing instructions adapted to be executed by a processor to perform a method of facilitating a display of investment information, said method comprising:
determining an amount of shares bid associated with each of a plurality of bid prices for an investment;
determining an amount of shares offered associated with each of a plurality of ask prices for the investment; and
arranging for indications of the amounts of shares bid and the amounts of shares offered to be graphically displayed so as to provide an investor with a direct sense of market depth associated with the investment.

20. A computer-implemented method of facilitating a display of information associated with shares of a stock, comprising:
receiving from an investor an indication associated with the stock;
determining an amount of shares bid associated with each of a plurality of bid prices for the stock;
determining an amount of shares offered associated with each of a plurality of ask prices for the stock;
arranging for an investment chart to be displayed to the investor, the investment chart including: (i) a first axis associated with share prices, and (ii) a second axis associated with numbers of shares bid and offered; and
arranging for indications of the amounts of shares bid and the amounts of shares offered to be displayed to the investor on the investment chart so as to provide the investor with a direct sense of market depth associated with the investment.

21. A method of facilitating a display of investment information, comprising:
determining an amount of shares bid associated with each of a plurality of bid prices for an investment;
calculating a bid value based on the amounts of shares bid and the bid prices;
determining an amount of shares offered associated with each of a plurality of ask prices for the investment;
calculating an ask value based on the amounts of shares offered and the ask prices; and
arranging for the bid value and the ask value to be displayed.

22. The method of claim 21, wherein the plurality of bid prices are associated with a pre-determined range of bid prices relative to a maximum outstanding bid price, and the plurality of ask prices are associated with a pre-determined range of ask prices relative to a minimum outstanding ask price.

23. The method of claim 21, wherein the plurality of bid prices are associated with a pre-determined threshold number of shares bid and the plurality of ask prices are associated with a pre-determined threshold number of shares offered.

24. The method of claim 21, wherein said calculations comprise calculating average values per share.

25. The method of claim 21, wherein said calculating the bid value comprises determining a minimum bid price and said calculating the ask value comprises determining a maximum ask price.

26. A method of facilitating a display of investment information, comprising:
determining a plurality of bid prices for an investment associated with a pre-determined number of shares bid;
calculating a bid value based on the bid prices;
determining a plurality of ask prices for the investment associated with a pre-determined number of shares offered;
calculating an ask value based on the ask prices; and
arranging for the bid value and the ask value to be displayed.

27. A method of facilitating a display of investment information, comprising:
determining an amount of shares bid associated with each of a plurality of bid prices for an investment;
determining an amount of shares offered associated with each of a plurality of ask prices for the investment;
calculating a current value based on the amounts of shares bid, the bid prices, the amounts of shares offered, and the ask prices; and
arranging for the current value to be displayed.

28. A method of displaying investment information, comprising:
requesting information associated with an investment; and
providing a graphical display including (i) an indication of amounts of shares bid associated with each of a plurality of bid prices and (ii) an indication of amounts of shares offered associated with each of a plurality of ask prices so as to provide an investor with a direct sense of market depth associated with the investment.
